(19) United States
(12) Patent Application Publication
(10) Pub. No.: US 2007/0202829 A1
(43) Pub. Date: Aug. 30, 2007

(54) Receiver for Narrowband Interference Cancellation

(75) Inventors: Raf Lodewijk Jan Roovers, Eindhoven (NL); Gerard Van Der Weide, Eindhoven (NL); Harish Kundur Subramaniyan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,270

(22) PCT Filed: Apr. 25, 2005
(86) PCT No.: PCT/IB05/51343

§ 371 Date: Oct. 25, 2006

(30) Foreign Application Priority Data
Apr. 29, 2004 (EP) 04101810.2

(51) Int. Cl. H04B 1/10

(52) U.S. Cl. 455/296

(57) ABSTRACT

A receiver is suitable for use in a wireless communications system, which is subject to interference from interfering signals having much narrower bandwidths than the wanted signal. In the receiver, an interfering signal is detected in the frequency domain and moreover, the cancellation also takes place in the frequency domain. Detection and cancellation in the frequency domain also provides a way of estimating the magnitude of the interfering signal, and hence also allows the wanted signal, at the frequency of the interfering signal, to be estimated.

This invention relates to a radio receiver, and more particularly to a receiver for use in a wireless communications system. More particularly, the invention relates to a system and a method for canceling the effect of an interfering signal from a received signal, in an Ultra Wideband wireless communications system, or another wireless communications system which is subject to interference from interfering signals having much narrower bandwidths than the wanted signal.

The term Ultra Wideband is used to refer to a number of different wireless communications systems. In one form of Ultra Wideband (UWB) communications system, data is sent from a transmitter to a receiver. Another form of UWB system can be used for object location or positioning, by transmitting signals from a device, and detecting reflected signals in a receiver within the same device.

One of the features of UWB communications systems is that signals are transmitted using a wide bandwidth. One problem which can arise with UWB communications systems is that an interfering signal, from another source of radio frequency signals, can potentially make it impossible for a receiver to detect the transmitted signal accurately.

Within the receiver, therefore, it is advantageous to be able to detect and then compensate for such interfering signals. In the document ‘A Novel Approach to In-Band Interference Mitigation in Ultra Wide Band Radio Systems’, Baccarelli, et al., IEEE Conference on Ultra Wideband Systems and Technologies, 2002, one possible solution to this problem is presented.

Specifically, in this document, it is proposed that the received signal be sampled, and then analyzed in the frequency domain. It is then proposed that interfering signals be detected, by examining the slope of the received signal spectrum, to test for sharp changes in the slope.

Once one or more interfering signals has been detected by this technique, the prior art document proposes generating a cancellation signal, which is equal and opposite to the estimated interfering signal. The document then proposes that this cancellation signal be sampled and added to the samples of the received signal in the time domain, before the signal is further processed.

According to the present invention, an interfering signal is detected in the frequency domain and, moreover, the cancellation also takes place in the frequency domain. If further processing of the signal is to be carried out in the time domain, then the resulting signal can be converted back into the time domain.

This has the advantage that the cancellation in the frequency domain also provides a way of estimating the magnitude of the interfering signal, and hence also allows the wanted signal, at the frequency of the interfering signal, to be estimated.

In the drawings:

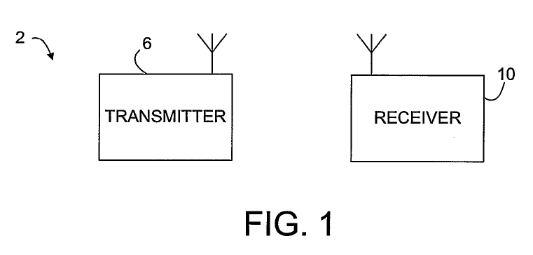

FIG. 1 is a block schematic diagram of a wireless communications system in accordance with an aspect of the present invention.

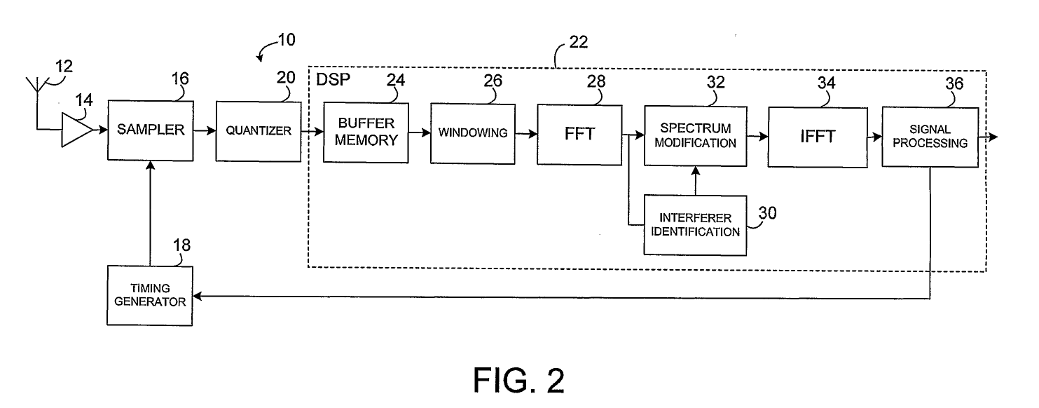

FIG. 2 is a block schematic diagram of a radio receiver in the wireless communications system of FIG. 1.

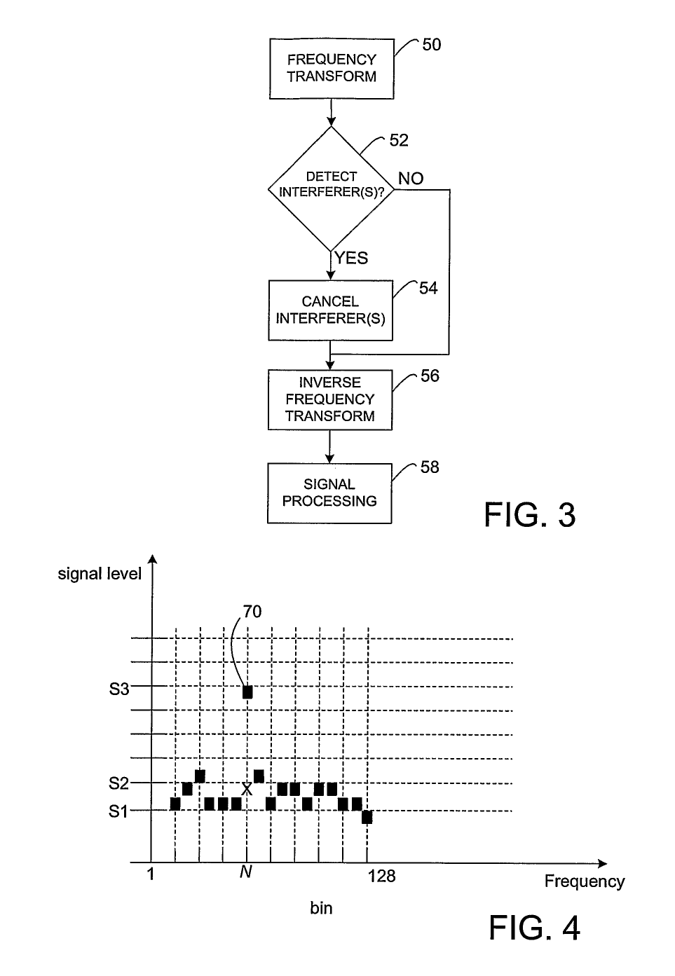

FIG. 3 is a flow chart illustrating a method of operation of the apparatus of FIG. 2.

FIG. 4 is an illustration of the frequency spectrum of a received signal, showing the effect of cancellation in accordance with the invention.

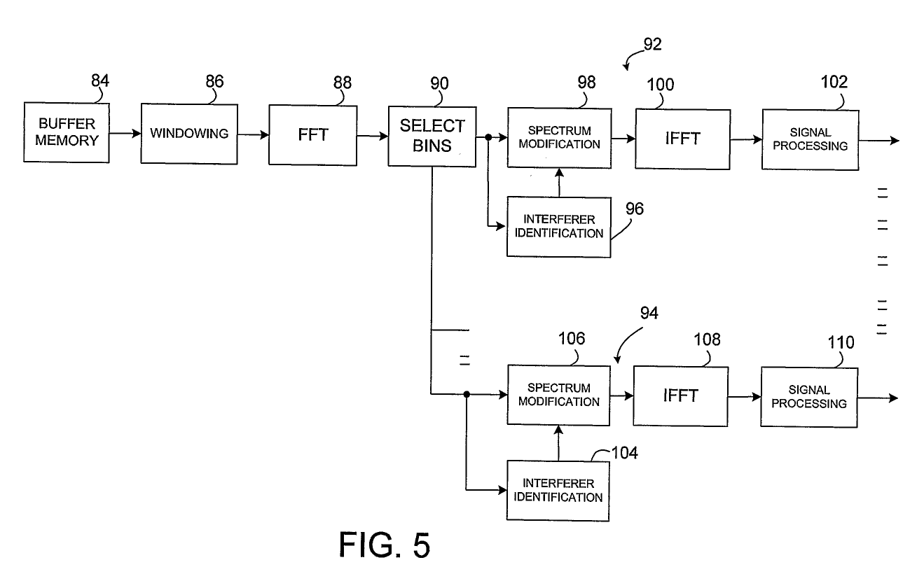

FIG. 5 is a block schematic diagram of an alternative radio receiver in accordance with the invention.

FIG. 1 is a block schematic diagram, showing the form of a wireless communications system 2, in which data is transmitted from a transmitter 6 to a receiver 10. More specifically, the wireless communications system is an Ultra Wideband (UWB) system. In an UWB communication system, signals are transmitted over a relatively wide part of the available bandwidth.

FIG. 2 shows in more detail the form of the receiver 10. In this embodiment of the invention, the receiver 10 is a digital UWB receiver. In this embodiment, transmitted signals are received at an antenna 12, and are then amplified in an amplifier 14. The amplified signals are then passed to a sampler 16. At times when a signal is expected, samples are taken at a very high rate. For example, 256 samples may be taken during an interval of 12.8 ns (that is, one sample every 50 ps). The sampler 16 operates under the control of a timing generator 18, which determines when pulses are expected to be received, and controls the timing of the samples. The samples are passed to a quantizer 20, which produces quantized samples. In a preferred embodiment of the invention, for example, the quantizer 20 may be a six bit quantizer or an eight bit quantizer.

The quantized received signals are passed to a digital signal processor (DSP) 22.

As will be described in more detail below, the DSP 22 is able to detect and cancel narrowband interfering signals. In accordance with the invention, this detection and cancellation take place in the frequency domain. The DSP 22 is therefore adapted to perform a frequency transformation on the quantized samples. In this illustrated embodiment of the invention, the frequency transformation is a digital Fast Fourier Transform (FFT) function.

In this illustrated embodiment of the invention, the samples are passed to a buffer memory 24, and then to a windowing block 26, before being passed to the FFT block 28. The person skilled in the art will recognize that the buffer memory and windowing block, although advantageous, are not essential features. The frequency transformed signal is passed to an interferer identification block 30, in which any narrowband interfering signals can be detected. The frequency transformed signal is also passed to a spectrum modification block 32. On the basis of any interfering signal detected in the interferer identification block 30, the spectrum modification block 32 adjusts the frequency transformed signal, which was generated by the FFT block 28. It is this modified signal which is then optionally passed to an inverse FFT (IFFT) block 34, for conversion back to the time domain.

The resulting signal is then passed to a signal processing block 36, where conventional functions are performed, such as pulse detection and timing extraction. The signal processing block 36 then operates to control the timing generator 18, so that the sampler 16 operates with the correct timing. The signal processing block 36 also extracts the transmitted data from the received signal.

Where the further processing of the signal is to be performed in the frequency domain, the modified signal, produced by the spectrum modification block 32, can be supplied to a suitable signal processing block.

FIG. 3 is a flow chart showing the method of operation of the DSP block 22 in the receiver of FIG. 2. Thus, in step 50, a frequency transformation, in this case a FFT operation is performed. In step 52, it is determined from the frequency spectrum of the signal whether there are any narrowband interfering signals. If so, the process passes to step 54, in which the spectrum is modified to cancel the or each interferer. Then, or in the event that no interfering signals are detected in step 52, the process passes to step 56, in which an inverse frequency transformation (in this case an inverse FFT) is performed. Finally, in step 58, the signal is further processed in the time domain.

FIG. 4 illustrates the way in which an interfering signal can be detected in accordance with step 52 of the process shown in FIG. 3, and can be cancelled in accordance with step 54 of that process.

Specifically, FIG. 4 shows the frequency spectrum of the signal, as generated by the FFT block 28. Thus, for each of 128 frequency bins, of which only a small number are shown in FIG. 4, the FFT block detects the signal level at that frequency, or the power of signals having frequencies within that narrow range. These signal levels are indicated in FIG. 4 by black rectangles.

It can be seen from FIG. 4 that, in this illustrative example, most of the signal levels fall within a relatively narrow range S1-S2. However, it is also immediately apparent that, in frequency bin N, the signal level S3 falls well outside that range.

This leads to the clear conclusion that this is the result not of the transmitted signal, but of a narrowband interfering signal at the frequency corresponding to bin N.

More generally, narrowband interfering signals can be detected in specific frequency bins by identifying bins in which the signal level exceeds a particular threshold value. This threshold value could for example be set with reference to the average value of the signal level over all of the frequency bins. That is, the threshold value could be set to exceed this average value by some amount, or by some percentage. Alternatively, the threshold value could be set at a predetermined value, for example set with reference to the maximum signal level, which can be handled by the system. Further, the threshold value could vary with frequency.

For example, in UWB communications systems, the shape of the frequency spectrum of the wanted signal is often known. In such cases, the threshold value can be set so that it follows the same shape.

In step 54, therefore, the effect of the interfering signal is cancelled. More specifically, the point in frequency bin N at power level S3, namely the black rectangle indicated in FIG. 4 by the reference number 70, is replaced by a point at a lower signal level, as indicated by a X in FIG. 4. In this illustrative case, the replacement point is chosen so that it is at a level which is the average of the signal levels in the two immediately adjacent frequency bins.

However, other possibilities exist for the selection of the replacement point. For example, rather than setting the replacement point at a level which is the average of the signal levels in the two immediately adjacent frequency bins, it can be set by interpolation between the signal levels in any number of adjacent frequency bins.

Further, as discussed above, in UWB communications systems, the shape of the frequency spectrum of the wanted signal is often known. In such cases, the signal level of the replacement point can be set accurately to the correct level by examining the signal levels in adjacent frequency bins, for example using a Least Mean Square (LMS) algorithm.

Thus, this allows for cancellation of interfering signals.

FIG. 5 is a block schematic diagram showing the form of the DSP block in an alternative embodiment of the invention. In this embodiment, as before, the quantized signal is passed to a buffer memory 84, and to a windowing block 86, and then to a FFT block 88. This embodiment of the invention is intended for use in a multiband UWB system, in which pulses are transmitted simultaneously in separate frequency bands of the overall available spectrum. In the receiver, therefore, it is necessary to process separately the signals received in these different frequency bands. This embodiment of the invention therefore uses the fact that the signal has been converted into the frequency domain, and the frequency transform signal is passed to a bin select block 90.

In the bin select block 90, those bins corresponding to a first frequency band are passed to a first path 92, and frequency bins corresponding to other frequency bands are passed to other corresponding paths. In this case only one other path 94 is shown, although it will be appreciated by the person skilled in the art that, in a multiband UWB system the spectrum may be divided into any convenient number of frequency bands.

In each of the paths 92, 94, respective interferers are then detected and cancelled as described above. Thus, in the first path 92, the spectrum is passed to an interferer identification block 96, and to a spectrum modification block 98, in which any point which results from the presence of an interferer is replaced by a point corresponding to the expected signal level value in that bin. As before, the modified spectrum is then passed to an IFFT block 100, and then to a signal processing block 102, for further signal processing functions, such as pulse detection, to be performed.

Similarly, in the path 94, the spectrum is passed to an interferer identification block 104, and to a spectrum modification block 106, in which any point which results from the presence of an interferer is replaced by a point corresponding to the expected signal level value in that bin. As before, the modified spectrum is then passed to an IFFT block 108, and then to a signal processing block 110, for further signal processing functions, such as pulse detection, to be performed, in the case where such signal processing is to be performed in the time domain.

A further modification of this alternative embodiment of the invention is possible. Specifically, the receiver of FIG. 5 may instead include a single interferer identification block, and a single spectrum modification block. Then, the bin select block 90 can pass the groups of bins, corresponding to the different frequency bands, sequentially to that interferer identification block and spectrum modification block. This would be efficient, in terms of the required hardware, provided that the required functions could be performed in the available time periods.

There is therefore proposed a receiver architecture which allows for cancellation of narrowband interfering signals, entirely in the frequency domain.

1. A radio receiver, comprising:
a sampler, for forming digital samples of a received signal;
a frequency transform block, for transforming the sampled received signal into the frequency domain; and
a signal processor, for modifying the frequency spectrum of the sampled received signal in the frequency domain.

2. A radio receiver as claimed in claim 1, further comprising:
an inverse frequency transform block, for transforming the sampled received signal with the modified frequency spectrum into the time domain.

3. A radio receiver as claimed in claim 1, wherein the signal processor is adapted to determine, from the frequency spectrum of the sampled received signal, frequency bands at which interfering signals are present.

4. A radio receiver as claimed in claim 3, wherein the signal processor is adapted to determine frequency bands at which interfering signals are present, by comparing signal levels at frequency bands within the received signal with respective threshold values.

5. A radio receiver as claimed in claim 4, wherein the threshold values are set for each of said frequency bands on the basis of signal levels at a plurality of said frequency bands within the received signal.

6. A radio receiver as claimed in claim 4, wherein predetermined threshold values are set for each of said frequency bands,

7. A radio receiver as claimed in claim 4, wherein the threshold values are set for each of said frequency bands on the basis of an expected shape of a frequency spectrum of the received signal.

8. A radio receiver as claimed in claim 3, wherein the signal processor is adapted to modify the frequency spectrum of the sampled received signal to cancel any detected interfering signals.

9. A radio receiver as claimed in claim 8, wherein the signal processor is adapted to modify the frequency spectrum of the sampled received signal by replacing signal level values, in frequency bands at which interfering signals are determined to be present, with estimated wanted signal level values.

10. A radio receiver as claimed in claim 9, wherein the signal processor is adapted to form an estimated wanted signal level value on the basis of signal level values in frequency bands adjacent to a frequency band at which an interfering signal is determined to be present.

11. A radio receiver as claimed in claim 9, wherein the signal processor is adapted to form an estimated wanted signal level value on the basis of an expected shape of a frequency spectrum of the received signal.

12. A radio receiver as claimed in any claim 1, wherein the radio receiver is an Ultra Wideband receiver.

13. An Ultra Wideband radio receiver as claimed in claim 12, comprising means for dividing the sampled received signal in the frequency domain into multiple frequency bands, each of which caries a respective signal, and each having a respective frequency spectrum, and wherein the signal processor is adapted to modify the frequency spectrum of the sampled received signal separately in said multiple frequency bands of the frequency domain.

14. A method of receiving a radio signal, comprising:
forming digital samples of a received signal;
transforming the sampled received signal into the frequency domain; and
modifying the frequency spectrum of the sampled received signal in the frequency domain.

15. A method as claimed in claim 14, further comprising:
transforming the sampled received signal with the modified frequency spectrum into the time domain.

16. A method as claimed in claim 14, further comprising determining, from the frequency spectrum of the sampled received signal, frequency bands at which interfering signals are present.

17. A method as claimed in claim 16, comprising determining frequency bands at which interfering signals are present, by comparing signal levels at frequency bands within the received signal with respective threshold values.

18. A method as claimed in claim 17, wherein the threshold values are set for each of said frequency bands on the basis of signal levels at a plurality of said frequency bands within the received signal.

19. A method as claimed in claim 17, wherein predetermined threshold values are set for each of said frequency bands.

20. A method as claimed in claim 17, wherein the threshold values are set for each of said frequency bands on the basis of an expected shape of a frequency spectrum of the received signal.

21. A method as claimed in claim 16, further comprising modifying the frequency spectrum of the sampled received signal to cancel any detected interfering signals.

22. A method as claimed in claim 21, comprising modifying the frequency spectrum of the sampled received signal by replacing signal level values, in frequency bands at which interfering signals are determined to be present, with estimated wanted signal level values.

23. A method as claimed in claim 22, comprising forming an estimated wanted signal level value on the basis of signal level values in frequency bands adjacent to a frequency band at which an interfering signal is determined to be present.

24. A method as claimed in claim 22 comprising forming an estimated wanted signal level value on the basis of an expected shape of a frequency spectrum of the received signal.

25. A method as claimed in claim 14, wherein the radio signal is an Ultra Wideband radio signal.

26. A method as claimed in claim 25, comprising:
dividing the sampled received signal in the frequency domain into multiple frequency bands, each of which caries a respective signal, and each having a respective frequency spectrum; and
modifying the frequency spectrum of the sampled received signal separately in said multiple frequency bands of the frequency domain.

27. A wireless communications system, comprising:
a radio transmitter, for generating and transmitting a radio signal; and
a radio receiver, wherein the radio receiver comprises:
a sampler, for forming digital samples of a received signal;
a frequency transform block, for transforming the sampled received signal into the frequency domain; and
a signal processor, for modifying the frequency spectrum of the sampled received signal in the frequency domain.

28. A wireless communications system as claimed in claim 27, wherein said radio receiver further comprises:
an inverse frequency transform block, for transforming the sampled received signal with the modified frequency spectrum into the time domain.

29. A wireless communications system as claimed in claim 27, wherein the signal processor is adapted to determine, from the frequency spectrum of the sampled received signal, frequency bands at which interfering signals are present.

30. A wireless communications system as claimed in claim 29, wherein the signal processor is adapted to determine frequency bands at which interfering signals are present, by comparing signal levels at frequency bands within the received signal with respective threshold values.

31. A wireless communications system as claimed in claim 30, wherein the threshold values are set for each of said frequency bands on the basis of signal levels at a plurality of said frequency bands within the received signal.

32. A wireless communications system as claimed in claim 30, wherein predetermined threshold values are set for each of said frequency bands,

33. A wireless communications system as claimed in claim 30, wherein the threshold values are set for each of said frequency bands on the basis of an expected shape of a frequency spectrum of the received signal.

34. A wireless communications system as claimed in claim 29, wherein the signal processor is adapted to modify the frequency spectrum of the sampled received signal to cancel any detected interfering signals.

35. A wireless communications system as claimed in claim 34, wherein the signal processor is adapted to modify the frequency spectrum of the sampled received signal by replacing signal level values, in frequency bands at which interfering signals are determined to be present, with estimated wanted signal level values.

36. A wireless communications system as claimed in claim 35, wherein the signal processor is adapted to form an estimated wanted signal level value on the basis of signal level values in frequency bands adjacent to a frequency band at which an interfering signal is determined to be present.

37. A wireless communications system as claimed in claim 35, wherein the signal processor is adapted to form an estimated wanted signal level value on the basis of an expected shape of a frequency spectrum of the received signal.

38. A wireless communications system as claimed in claim 27, wherein the wireless communications system is an Ultra Wideband wireless communications system.

39. A wireless communications system as claimed in claim 38, wherein the transmitter is adapted to divide an available bandwidth into multiple frequency bands, each of which caries a respective signal, and wherein the receiver is adapted to divide the sampled received signal in the frequency domain into said multiple frequency bands, each having a respective frequency spectrum, and wherein the signal processor is adapted to modify the frequency spectrum of the sampled received signal separately in said multiple frequency bands of the frequency domain.
